(19) United States
(12) Patent Application Publication
(10) Pub. No.: US 2004/0201795 A1
(43) Pub. Date: Oct. 14, 2004

(54) Liquid crystal display with internal polarizer

(76) Inventor: Michael V. Paukshto, San Mateo, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/656,516

(22) Filed: Sep. 4, 2003

Related U.S. Application Data
(60) Provisional application No. 60/461,686, filed on Apr. 9, 2003.

(51) Int. Cl. G02F 1/1335

(52) U.S. Cl. 349/96

(57) ABSTRACT

A liquid crystal display is provided comprising a front panel, a rear panel, and a liquid crystal layer placed between the front and rear panels. At least one of the front and rear panels comprises an internal polarizer situated between an electrode and a substrate in the panel. The internal polarizer is made of a highly temperature durable material that is chemically stable at an elevated temperature of at least 150° C.

### CROSS REFERENCES FOR RELATED APPLICATIONS

This application claims priority to the U.S. Provisional Patent Application No. 60/461,686, filed Apr. 9, 2003, entitled LIQUID CRYSTAL DISPLAY WITH INTERNAL POLARIZER, the disclosure of which is hereby incorporated by reference in its entirety.

### BACKGROUND

This invention relates to liquid crystal displays and related devices, and particularly to liquid crystal displays having polarizers.

Liquid crystals were first used as the base of devices displaying visual information in the early 1970s. Low energy consumption and small dimensions of these devices as compared to the analogous systems of other types rapidly made liquid crystal displays indispensable elements of portable and mobile devices. Subsequent development of the liquid crystal technology showed the ability of these devices to display high-quality color graphic images, while retaining the advantages of small size and weight, low energy consumption, and relatively low price. This combination of properties allowed the scope of liquid crystal display applications to be greatly expanded. At present, liquid crystal displays are used virtually in all fields of technology, including displays of portable computers, calculators, and related devices; control display panels of portable and miniature instruments, and sensors; displays of mobile and portable home appliances and related devices such as mobile telephones, pocketbooks, e-books, notebooks, and electronic watches; projectors and large-size screens for cinemas, exhibitions, public places and events, etc.

Liquid crystal displays are known since the late 1970s and the device structures have been described in sufficient detail by S. -T. Wu, D. -K. Yang, Reflective Liquid Crystal Displays, Wiley (2001); E. Lueder, Liquid Crystal Displays: Addressing Schemes and Electro-Optical Effects, Wiley (2001). A liquid crystal display structure comprises a system of flat layers performing various functions.

It is possible to distinguish between at least two types of liquid crystal displays: reflective and transmissive. The two types differ in the mode of light passage through layers of the liquid crystal display. In a reflective liquid crystal display, the light enters the structure, of the liquid crystal display. In a reflective liquid crystal display, the light enters the structure, reflects from a reflective layer, and exits from the same side. In a transmissive liquid crystal display, the light enters the structure on one side, passes through the system, and exits from the opposite side.

In practice, however, the difference between the two types of liquid crystal displays is related to the use of an external illumination source or a lighting system. The lighting system is usually any light source that provides for a uniform transillumination of the liquid crystal display layers.

In the reflective liquid crystal displays, the lighting system can be absent: such liquid crystal displays employ the light from ambient sources. The function of the reflective layer is to reflect the light from these sources toward the observer. Sometimes, such liquid crystal displays are also provided with an internal front lighting system ensuring operation of the displays in the dark.

In the transmissive liquid crystal displays, the lighting is provided by an external source transilluminating the system from the rear side. This case is referred to as the backlighting system.

Besides the liquid crystal displays of the two main types, there are devices combining both principles. Such displays are called transflective or transreflective. The combination is provided by introducing a semitransparent reflective layer and a backlighting source into a reflective liquid crystal display.

In describing liquid crystal displays, it is convenient to differentiate between front and rear sides. The front side is that facing the observer, and the rear side is that opposite to the front side. The sets of layers in the liquid crystal display structure situated in front of and behind the liquid crystal layer are usually referred to as the front and rear layers, respectively. For example, there are rear and front substrates, rear and front electrodes, etc. The layers in the liquid crystal display structure situated in front of the liquid crystal layer are frequently referred to as the front panel, while the layers behind the liquid crystal layer are called the rear panel.

In order to create an image on the display, the light flux from a backlighting system is modulated by the liquid crystal display structure. Besides the reflective layer and the light source, the image is controlled by the functional layers of liquid crystal and at least one polarizer.

The principle of the liquid crystal display operation is based on the polarization state of light (polarized by one of the polarizers) being controlled in the liquid crystal by a voltage applied to the electrodes.

Depending on the liquid crystal display type (reflective versus transmissive), the functional order of the polarizer and liquid crystal layers can be as follows.

In a reflective liquid crystal display, a front polarizer is followed by a liquid crystal and a reflective layer. In order to increase the liquid crystal display contrast ratio, a second polarizer is frequently introduced between the liquid crystal and the reflective layer. As is indicated above, the light from ambient sources or front lighting system passes through the liquid crystal display structure twice: from the front side to reflective layer and back to the observer.

In a transmissive liquid crystal display, a front polarizer is followed by a liquid crystal and a rear polarizer. Here, the light passes through the liquid crystal display structure only in one direction, from backlighting system to the observer and, hence, a second polarizer is necessary.

In a transflective liquid crystal display, a front polarizer is followed by a liquid crystal layer, a rear polarizer, and a semitransparent reflective layer. In this scheme, the rear polarizer is also necessary.

A polarizer layer is frequently applied onto the outer surface of the front substrate, which is usually related to features of the liquid crystal displays and polarizer manufacturing technology. In this case, the polarizer is referred to as external. In liquid crystal display projectors, the polarizers are of prism type. Large dimensions and considerable dissipated power determine the external arrangement of such polarizers.

In the case of a sheet polarizer, the external arrangement has several disadvantages. An additional protective layer is necessary to prevent the damage of polarizer by the external mechanical factors (scratching, impact). Color filters used for image formation in chromatic liquid crystal displays may produce a depolarization of the transmitted light. In this case, a polarizer is helpful to remove this depolarization but this is not possible for a system with external polarizer layer. Also because of a relatively large substrate thickness, the use of external polarizers significantly increases the light pathlength in the liquid crystal display structure, which leads to the loss of brightness and contrast and increases image distortions at oblique viewing angles.

For the liquid crystal display with external polarizers situated on the outer side of a substrate the substrate is protecting internal layers from the action of external factors and it also frequently serves as a carrying element of the whole mechanical structure. For technological reasons, the thickness of a substrate is relatively large and, hence, a polarizer situated on the outer side of the substrate significantly increases the pathlength of light rays in the display. In connection with this, the main disadvantages of these display designs are small viewing angle, sensitive to mechanical action (related to the risk of damaging external polarizers), and complicated manufacturing technology related to the need in additional layers protecting the external polarizer (leading to a strong parallax or doubling of the image).

The above disadvantages inherent in the liquid crystal displays with external polarizers led to the development of various methods for obtaining liquid crystal displays with internal polarizers situated between the substrates. In many of such variants, it was simultaneously suggested to provide for the following: arrange the internal polarizer layer between electrode and liquid crystal, and combine the functions of polarizer and alignment layer in one layer.

U.S. Pat. No. 3,941,901 teaches a method of manufacturing internal polarizers for liquid crystal displays, which is based on the alignment of long chains of a vinyl polymer near the substrate surface. The procedure consists of dissolving a polymer, applying the solution onto a substrate, and producing a shear strain with simultaneous thinning of this layer. Then the solvent is evaporated to leave a thin layer of oriented polymer molecules on the substrate surface. It is pointed out that, by depositing such layer onto a substrate and using the polymer representing a dichroic dye, it is possible to obtain a polarizer, which can simultaneously perform the function of an alignment layer.

U.S. Pat. No. 4,241,984 describes a liquid crystal display with an internal polarizer layer, in which a polarizer possessing alignment properties performs the double function of polarization and alignment. The combination of polarizing and aligning functions, large capacitance and large switching time of the polarizer confined between electrodes of the display structure, relatively large thickness of the polarizer, and decreasing optical characteristics of the display make the manufacturing technology to be more complicated and less flexible. Another drawback is that the liquid crystal layer is always oriented along the polarizer axis, which makes impossible the operation modes in which these directions are not coinciding.

WO 9,739,380 describes a liquid crystal display with an internal polarizer in which a polarizing layer is grown immediately on a substrate from a dichroic dye solution in a lyotropic liquid crystal. One disadvantage of this liquid crystal displays is the need in creating a polarizer layer immediately in the course of the liquid crystal display manufacturing, using a certain material applied by definite means, which complicates the technology and limits the choice of materials for the functional elements of the liquid crystal displays.

U.S. Pat. No. 6,417,899 B1 describes a liquid crystal display with an internal polarizer in which a polarizing film is grown on a special alignment layer between the electrode and substrate. Disadvantages of this solution are complicated technology and limited choices of the polarizer material, since the polarizing film must be grown over the alignment layer immediately in the course of liquid crystal display manufacturing.

### SUMMARY OF THE INVENTION

Accordingly, one of the objectives of the disclosed invention is to provide a liquid crystal display (LCD) with an internal polarizer that overcome the disadvantages of prior art LCDs, including high working voltage, low multiplexing rate, possible chemical interaction between the liquid crystal layer and the internal polarizer layer, and also complication of manufacturing technology.

These and other objectives are achieved by the liquid crystal display of the invention which comprises a front panel, a rear panel, and a liquid crystal layer placed between the front and rear panels. At least one of the front and rear panels comprises an internal polarizer positioned between an electrode and a substrate in the same panel. The internal polarizer is made of a material chemically stable at an elevated temperature of at least 150° C.

### BRIEF DESCRIPTION OF THE DRAWINGS

The invention will be more clearly understood from the following description when read in conjunction with the accompanying drawings in which:

FIG. 1 (prior art) is a schematic showing a liquid crystal display with external polarizers.

FIG. 2 (prior art) is a schematic showing a liquid crystal display comprising two internal polarizers placed between electrodes.

FIG. 3 is a schematic showing a liquid crystal display including an internal polarizer placed between an electrode and a substrate according to one embodiment of the invention.

FIG. 4 is schematic showing a reflective liquid crystal display according to one embodiment of the invention.

FIG. 5 is a schematic showing a transflective liquid crystal display according to one embodiment of the invention.

FIG. 6 is a schematic showing a liquid crystal display including a reflecting layer that additionally functions as an electrode according to one embodiment of the invention.

FIG. 7 is a schematic showing a transmissive liquid crystal display according to one embodiment of the invention.

### DETAILED DESCRIPTION OF THE INVENTION

As used herein, the term “front” when used to describe substrates, electrodes, polarizers, transmission axes and alignment directions means that the described element is located on the viewer side of the liquid crystal.

As used herein, the term “rear” when used to describe substrates, electrodes, polarizers, transmission axes and alignment directions means that the described element is located on side of the liquid crystal opposite to the viewer.

The present invention provides a liquid crystal display including at least one internal polarizer as well as electrodes, substrates, and other functional layers. The internal polarizer is situated between the electrode and the substrate in the front panel, or between the electrode and the substrate in the rear panel. In this embodiment, the substrates provide protection for the alignment layers and electrodes from the action of external factors, thus the working voltage for controlling the liquid crystal is reduced. The internal polarizer is made of a material of a high temperature durability, namely a material chemically stable at an elevated temperature of at least 150° C.

The LCD manufacturing process includes several stages which require high temperature durability of all layers in a panel. These stages include ITO sputtering process and polyimide baking. Indium Tin Oxide or ITO is a commonly used material for an electrode in liquid crystal cells. Polyimide is a material used in LCD manufacturing as an alignment layer for liquid crystal material. An additional protective layer may be used in order to protect the polarizer during ITO etching process.

In one embodiment of the invention, the layer structure of the liquid crystal display is as follows. The liquid crystal layer is sandwiched between the alignment layers which are in contact with the front and rear surfaces of the liquid crystal layer. The liquid crystal with adjacent alignment layers is situated between electrodes. At least one front or rear panel comprises at least one internal polarizer made of a material of a high temperature durability, and situated between the substrate and an electrode.

In another embodiment of the present invention, one of the front and rear panels has an internal polarizer among its functional layers, another panel has an external polarizer.

In another embodiment of the present invention, the transflective liquid crystal display may contain at least two external polarizers in addition to the internal polarizer. At least one external polarizer is situated on the same panel as the internal polarizer according to the present invention.

The present invention does not require the external polarizer to be of a high temperature durable material—though it is possible to use this material for the external polarizer as well.

In another embodiment of the present invention, the internal polarizer does not cover the whole substrate surface. This design with a partial internal polarizer can be used in some designs which combine the features of the transmissive and reflective designs in one display.

Any other auxiliary layers between the electrode and polarizer and/or between the polarizer and substrate are not required, although such auxiliary layers can be provided when desired for particular applications.

It is possible to select materials for the polarizer and the auxiliary functional layers according to the present invention. Prior art LCDs require particular materials for the polarizing film, special auxiliary layers and special manufacturing technologies. These factors complicate the polarizer technology as a result of the limitation of materials and introduction of additional technological operations.

The polarizer used in the liquid crystal displays can be either a flat sheet with nonlinear optical properties or a device of Taylor-Glan prism type. Taylor-Glan prism devices are typically used in the projection systems.

In one embodiment of the invention, the polarizer represents a thin crystal film (TCF) available from Optiva, Inc., California, USA. This optically anisotropic dichroic crystal film has a small thickness, low temperature sensitivity, highly anisotropic refractive indices, and large dichroic ratio. These properties of the TCF are related to the materials and method used for making the film. The TCF of the invention has a special molecular-crystalline structure formed as a result of crystallization of a liquid crystal phase, upon application of a liquid crystal onto an appropriate substrate, alignment, and drying. The liquid crystal phase contains at least one organic substance capable of forming a stable lyotropic or thermotropic liquid crystal phase. The organic substance comprises at least one organic compound, the formula of which includes (i) at least one ionogenic group ensuring solubility in polar solvents for obtaining a lyotropic liquid-crystalline phase, and/or (ii) at least one nonionogenic group ensuring solubility in nonpolar solvents for obtaining a lyotropic liquid-crystalline phase, and/or (iii) at least one counterion, which may be or may not be retained in the molecular structure after formation of the film.

The optically anisotropic dichroic crystal film comprises a great number of supramolecular complexes of one or several organic compounds. These supramolecular complexes are oriented in a certain manner so as to provide electric conductivity and polarization of the transmitted light. The film is comprised of rodlike supramolecules, which comprise at least one disc-shaped polycyclic organic compound with conjugated π-system. The film has a globally ordered crystal structure with an intermolecular spacing of 3.4±0.3 Å along its polarization axis.

The base material for the optically anisotropic dichroic crystal film is selected based on the presence of a developed π-conjugated bond system in conjugated aromatic rings and the presence of groups such as amine, phenol, ketone, etc. lying in the plane of the molecule and connected with the conjugated bond system. The molecules and/or the molecular fragments possess a planar structure. Examples of the base materials are indanthrone (Vat Blue 4), 1,4,5,8-perylenetetracarboxylic acid dibenzoimidazole (Vat Red 14), 3,4,9,10-perylenetetracarboxylic acid dibenzoimidazole, quinacridone (Pigment Violet 19), etc., the derivatives of which (or their mixtures) are capable of forming a stable lyotropic liquid crystal phase. The transmission spectrum of the film in the visible range can be taken into account when materials for the TCF are selected. Using dyes as the initial compounds can provide the possibility of using thin crystal film polarizers as correcting color or neutral filters and/or as ultraviolet or infrared filters.

A formed colloidal lyotropic liquid crystal system is formed of molecules aggregated into supramolecular complexes constituting kinetic units of the system. These supramolecular complexes are oriented in a certain manner so as to provide electric conductivity and polarization of the transmitted light. WO 01/63346 describes a colloidal lyotropic crystal system, the disclosure of which is hereby incorporated by reference. This lyotropic liquid crystal phase is essentially a precursor of an ordered system from which a solid optically anisotropic dichroic crystal film is formed in the course of subsequent alignment of the supramolecular complexes and removal of the solvent.

In the optically anisotropic dichroic crystal film, the molecular planes are parallel to each other and the molecules form a three-dimensional crystal structure, at least in part of the crystal film. Optimization of the production technology may allow the formation of an optically anisotropic dichroic single crystal film. The optical axis in this single crystal is perpendicular to the plane of molecules. Such thin crystal films possess a high degree of anisotropy and exhibit, at least in one direction, high refractive index and/or high absorption coefficient.

Another important feature of the optically anisotropic dichroic crystal films is their high temperature durability. For comparison, the thermal stability of iodine-type polarizers is typically limited to maximum temperature of 80° C. As it was shown in Bobrov, Y. et al., “Environmental and optical testing of Optiva Thin Crystal Film™ Polarizers”, Proc. of the 10^{th} SID Symposium “Advanced display technologies”, Minsk, Republic of Belarus, September 18-21, 2001, 23-30 and Ignatov, L. et al. (2000). “Thin Film Polarizers: Optical and Color Characteristics. Thermostability”, SID, Int. Symp. Digest of Technical Papers, Long Beach, Calif. May 16-18, Vol. XXXI, 834-838, the optically anisotropic dichroic crystal films of the present invention manufactured by Optiva, Inc. (Optiva TCF™) has a high temperature durability at elevated temperatures higher than 150° C. The recent studies have shown that there is a chemical durability of the films up to 270° C. The LCD manufacturing procedure requires a relatively short exposure to the temperatures between 200° C. and 250° C., and the Optiva TCF™ make possible to have an internal polarizer in liquid crystal displays and apply it on the stage preceding ITO sputtering and/or PI baking.

It is possible to mix colloidal systems which leads to the formation of combined supramolecules to provide a crystal film that possesses intermediate optical characteristics. In the optically anisotropic dichroic crystal films obtained from mixed colloidal solutions, the absorption coefficient and refractive index can take various values within the limits determined by the initial components. Such a mixing of different colloidal systems with the formation of combined supramolecules is possible due to the coincidence of one characteristic dimension (intermolecular spacing of 3.4±0.3 Å) of the organic compounds employed. The thickness of the optically anisotropic dichroic crystal film is determined by the content of solid substances in the applied solution. During the formation of the film, a technological parameter conveniently controlled under commercial production conditions is the solution concentration. The degree of crystallinity of the final crystal film can be monitored by X-ray diffraction and/or by optical methods. Substrates onto which the thin crystal film is applied can be subject to additional processing to ensure homogeneous wetting of the surface for providing surface hydrophilicity. The possible treatments include mechanical processing, annealing, and mechano-chemical treatment, etc. Prior to application of a thin crystal film, the substrate surface can be mechanically processed so as to form anisotropic alignment structures, which can increase the orientation degree of molecules in the obtained thin crystal films.

The polarizer can be processed to form a surface microroughness characterized by a certain special direction so that the polarizer can perform the function of an alignment layer.

The required anisotropy of the absorption coefficients and refractive indices, as well as the orientation of the principal axes (i.e., the optical properties of the electrooptical anisotropic thin crystal film in a multilayer structure) can be ensured by establishing a certain angular distribution of molecules in the polarizing film at the substrate surface.

The optical properties of the thin crystal film can be controlled by the aforementioned methods in the course of fabrication so that the layer characteristics can be adjusted according to the requirements of various particular applications. For example, it is possible to modify the absorption spectrum of the polarizer, which can provide for the improved color rendering and achromatism of the display. The birefringent films can be used as phase retarders with preset phase shift at a given wavelength. By changing the optical anisotropy of the films, it is possible to improve angular characteristics of the liquid crystal displays with thin film crystal polarizers.

The optical dichroism of the film makes it possible to use such polarizers as phase retarders to improve the contrast ratio and/or angular characteristics of liquid crystal displays.

Another important feature of the Optiva TCF™ polarizers of the present invention is their small thickness. The characteristic of a liquid crystal display highly depends on the thickness of layers in the design. One of the reasons that the conventional polarizers, in particular PVA-based, are not used as internal polarizer even with a protective layer applied is that their thickness with a protective layer is larger than 200 microns.

The Optiva TCF™ polarizers have a thickness less than 1 micron, and even with additional layers if required its thickness is substantially lower than the conventional polarizers, for example of the iodine-type.

The position of the polarizer relative to the other layers in the display depends on the polarizer type. A polarizer of prism type is typically situated in the front and outside the liquid crystal display layer structure. A thin crystal film polarizer can be situated between other liquid crystal display layers.

The liquid crystal display includes other functional layers required for the proper operation of the display. The image control in the liquid crystal display is provided by electrode layers. The electrode layer material desirably possesses a sufficiently low resistance and provides a contact for a control voltage supply. Further, the electrode is desirably transparent so as to obtain a sufficiently bright image. In most cases, the electrodes are made of transparent conducting materials of indium tin oxide (ITO) type. In some liquid crystal displays, for example, of a single-polarizer reflective type, one of the electrodes can be nontransparent.

The alignment layers (aligners) provide for orientation of liquid crystal molecules in the nematic phase. The alignment layers determine the twist angle of the liquid crystal and are typically in direct contact with liquid crystal. Generally, the alignment layers are made of a polymer material such as polyamide (e.g., SE 3210 Nissan).

The substrates in the liquid crystal display provide protection for aforementioned functional layers from the action of external factors and serve as mechanical base elements. The substrates are usually made of a transparent material such as glass or plastic, with a typical thickness of about 0.7 mm and a refractive index of about 1.5.

The thicknesses and materials of the auxiliary layers are selected based on their functions and transparency requirement in the wavelength range from 400 to 700 mn.

The liquid crystal display may include other layers in order to improve the image quality and electrical characteristics, and prevent undesired physical and chemical interactions between neighboring layers and for other purposes.

For example, phase-retarding (phase compensation) or retardation layers can be used to increase the image quality and color reproduction. According to the disclosed invention the retardation layer can be located on one or on both panels of the display. In some embodiments the retarder layer is made of the thermostable material as one manufactured by Optiva, Inc.—see for example Lazarev, P., et al. “Submicron Thin Retardation Coating”, SID, Int. Symp. Digest of Technical Papers, San Jose, Calif., June 2001, Vol. XXXII, pp. 571-573, and T. Fiske, et al. “Molecular Alignment in Crystal Polarizers and Retarders”, SID, Int. Symp. Digest of Technical Papers, Boston, Mass., May 2002, pp. 866-869. The Optiva TCF retarder is a thin film layer which can be used inside the liquid crystal cell in different positions in relation to other functional elements of the liquid crystal display. In some embodiments the liquid crystal display with the internal polarizer may have the TCF retarder layer situated between the internal polarizer and an electrode on the same panel. Yet in another embodiment the liquid crystal display that is designed with an internal and external polarizers situated on one panel may have the TCF retarder layer situated either between the internal polarizer and an electrode or between two polarizers.

Additional protective layers can be used to prevent other layers from damage during the manufacturing and operation of the liquid crystal display. For example, an external front polarizer is desirably protected by a special outer layer. Insulating layers (e.g., SiO₂) can increase the resistance between electrodes and protect the liquid crystal display structure from electric breakdown. Adhesive layers can provide for a better mutual adhesion of the functional and auxiliary layers. Planarization layers can be used to level the roughness on the liquid crystal display elements. For example, undesired interference effects can be suppressed by diffusive reflecting layers possessing rough surfaces. Matrices with color filters can be used for the color image formation in chromatic liquid crystal displays. Diffusive scattering layers can be used to increase the viewing angle and suppress undesired interference. Antireflection coatings can be used to improve the contrast ratio, and so on.

Various functions can be combined and performed by one layer made of a special material or formed by a special method. For example, the liquid crystal display may comprise a reflective polarizer, or reflective electrode, or polarizer/alignment layer.

Some other functional layers can also be arranged between the electrode and substrate layers, as long as these layers do not hinder the proper functioning of the liquid crystal display and affect the achieved technical results.

For example, the existing technology of electrode layer formation using photolithography followed by etching requires using a protective acrylic layer to prevent the polarizer from contact with the etching solution. The acrylic layer is deposited onto the polarizer on the side facing the electrode. In addition to protecting the polarizer from etching in the course of electrode formation, the acrylic layer also protects the polarizer layer components (e.g., metal ions) from dissolving in operation of the liquid crystal display.

The other side of the polarizer can also contact an additional layer, for example, a planarization layer leveling the roughness of a diffusive mirror in a reflective display or a layer protecting the polarizer from diffusion of aluminum ions from a specular reflecting layer in the reflective display.

The space between the electrode and liquid crystal layer can also accommodate additional polarizers, phase retarders, color filter matrices, and adhesive films, etc.

In another embodiment, the thickness and the order of the functional layers is selected so as to ensure an interference extremum at the display output for at least one wavelength in the spectral range from 500 to 600 nm. This is desirable in order to ensure the high brightness of the display in the range of maximum sensitivity of human eye.

The LCD of the disclosed invention can include several polarizers. Generally, a liquid crystal display structure includes two polarizing layers, one on each side of the liquid crystal layer. Each of the polarizers can be arranged according to the proposed functional order of layers. At the same time, the quality of the polarizer can be increased by using a pair of polarizing layers with intermediate adhesive on each side of the liquid crystal. Such a double polarizer can also be arranged between the electrode and substrate on one side of the liquid crystal. Reducing the thickness of polarizers can further increase the liquid crystal display performance. For example, a standard iodine polarizer employed in most liquid crystal displays is about 100 micron thick. The polarizer used in the liquid crystal display of the present invention has a thickness as small as one micron, or below. The polarizer is made of an optically anisotropic dichroic liquid crystal film. The polarizers made of the TCF have extremely small thickness, low temperature sensitivity, highly anisotropic refractive indices, favorable angular characteristics, high polarizing ability at oblique angles, large dichroic ratio.

Another embodiment of the present invention discloses the liquid crystal design that has a high temperature durable internal polarizer on one panel and an external polarizer on another panel. Two designs can be considered in this case. One has an internal polarizer in a rear panel, and another in a front panel. In this embodiment the external polarizer can be either a high durable polarizer as the one used as an internal polarizer, or a polarizer of any type. The designs of this embodiment can be used for any type of liquid crystal display including reflective, transmissive and transflective designs, and the designs will feature the aforementioned advantages of the liquid crystal display disclosed.

Still another embodiment of the present invention is a liquid crystal display that further comprises a retardation layer. This retardation layer can be also made of the high temperature durable materials.

Another embodiment of the present invention is a transflective liquid crystal display which comprises three polarizers—two of which are external polarizers and one internal polarizer. In this embodiment one or both external polarizers can be either high durable polarizers as the one used as an internal polarizer, or a polarizer of any type. This design will feature the aforementioned advantages of the liquid crystal display disclosed.

The present invention will now be described with reference to the accompanying drawings.

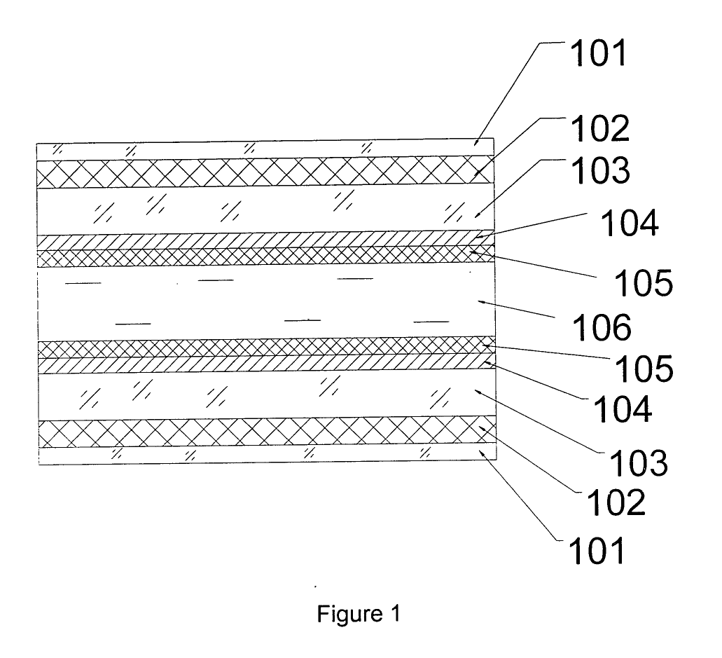

FIG. 1 (prior art) shows a liquid crystal display with two external polarizers. The liquid crystal display comprises two protective layers 101 protecting two external polarizers 102 from scratching, and moisture, etc. from both sides of the display. The polarizers 102 are placed on the corresponding transparent substrates 103. The liquid crystal display comprises two electrodes 104, two alignment layers 105 and liquid crystal layer 106. In addition to protective layers 101, the liquid crystal display shown in FIG. 1 is characterized by large thickness and increased pathlength of the light. These factors lead to decreased angular characteristics.

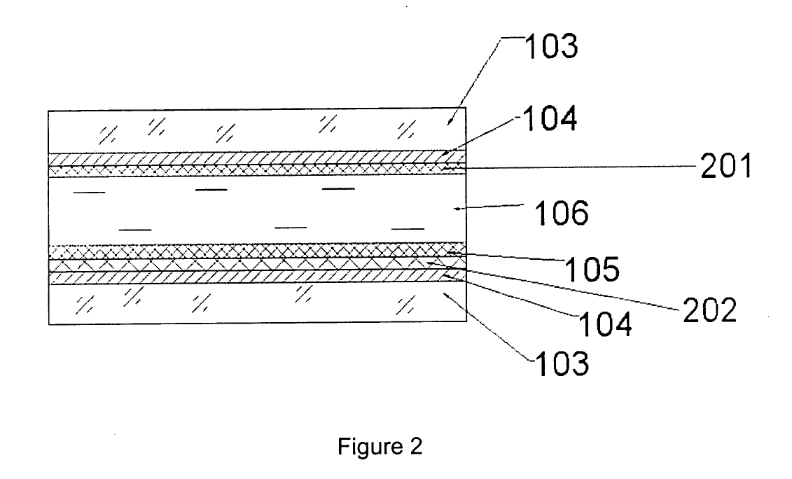

FIG. 2 (prior art) shows a liquid crystal display with two internal polarizers, both placed between electrodes 104. The first internal polarizer 201 is placed between electrode 104 and liquid crystal layer 106 in the front panel and performs the function of an alignment layer for the liquid crystal layer 106. The second polarizer 202 is placed between alignment layer 105 and electrode 104 in the rear panel. This design does not require combining alignment layer 105 and the second polarizer 202 in a single layer. This design requires high working voltage and may have low multiplexing rate, etc. due to the arrangement of the polarizer layers 201 and 202 between electrodes 104. These disadvantages are related to the relatively high dielectric permittivity of the polarizer materials. The LCD shown in FIG. 2 has another disadvantage of direct contact between the first polarizer/alignment layer 201 and liquid crystal layer 106. This may cause intermixing between layers by solid state diffusion, which can poison the polarizer 201 and/or the liquid crystal layer 106.

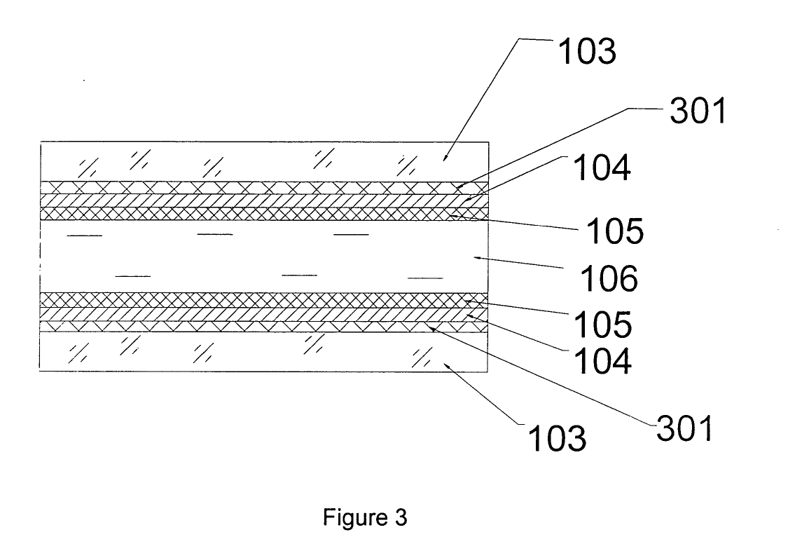

FIG. 3 shows a liquid crystal display according to one embodiment of the disclosed invention. Two internal polarizers 301 are placed between electrodes 104 and transparent substrates 103 in the front and rear panel respectively. Between electrodes 104 there contains a liquid crystal layer 106 and two alignment layers 105 at both sides of the liquid crystal layer 106. The use of internal polarizers 301 in the LCD shown in FIG. 3 widens the viewing angle, improves the angular characteristics, lowers the display thickness, simplifies the display design, and substantially enhances the protection of the polarizer layer against scratching and moisture. Further, the arrangement of the internal polarizers 301 outside the electrodes 104 reduces the working voltage and increases the multiplexing rates of the display. In addition, the arrangement of electrodes 104 between the internal polarizer layers 301 and the liquid crystal layer 106 in each of the panel provides protection of the liquid crystal layer and the polarizer layer from the diffusion poisoning. According to another embodiment of the present invention which is not shown in this figure, the transmissive LCD can have a different design where only one of two panels have an internal polarizer, and another panel has an external polarizer among its functioning layers.

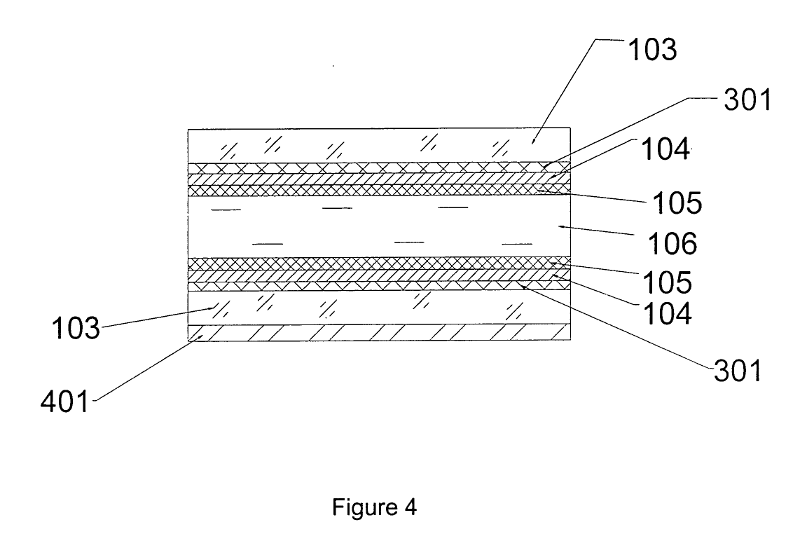

FIG. 4 shows a reflective LCD that includes a reflective layer 401 according to one embodiment of the disclosed invention. The reflective layer 401 enables the LCD to form images using the light from ambient sources or with front lighting source. The reflective LCD also substantially reduces power consumption. According to another embodiment of the present invention which is not shown in this figure, the reflective LCD can have a different design where only one of two panels have an internal polarizer, and another panel has an external polarizer among its functioning layers.

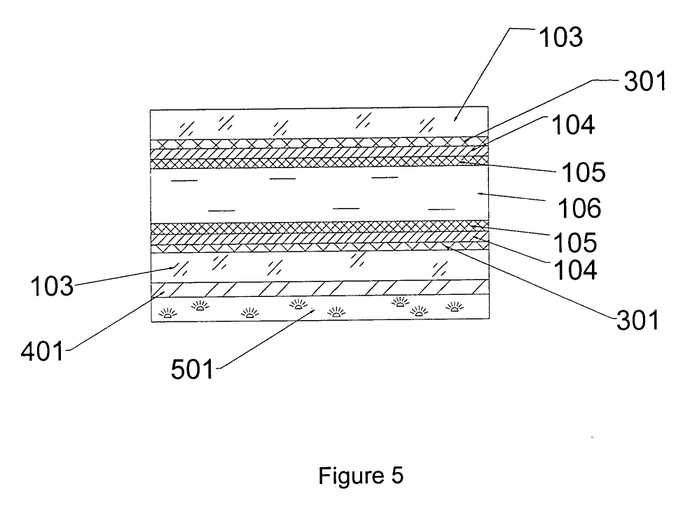

FIG. 5 shows a transflective LCD according to one embodiment of the disclosed invention. The LCD includes a reflective layer 401 that is semitransparent. A backlighting system 501 is arranged on the rear side- of the liquid crystal display. The semitransparent reflective layer and the backlighting system provide a LCD of transflective type. The transflective LCD combines the advantages of the LCDs of reflective and transmissive types. Along with the backlighting source the transflective LCD can also use either an ambient light source or a front lighting source.

According to another embodiment of the present invention, the transflective LCD can have several different designs. According to one of them only one of two panels has an internal polarizer, and another panel has an external polarizer among its functioning layers. In another embodiment, at least three polarizers are included, two of which are external polarizers and one internal polarizer. In this embodiment one or both external polarizers can be either high durable polarizers as the one used as an internal polarizer, or a polarizer of any type. Yet another embodiment which is not specifically illustrated in this specification the internal polarizer does not cover the whole substrate surface, in other words its surface area on an optical path is smaller than an area covered by liquid crystal material.

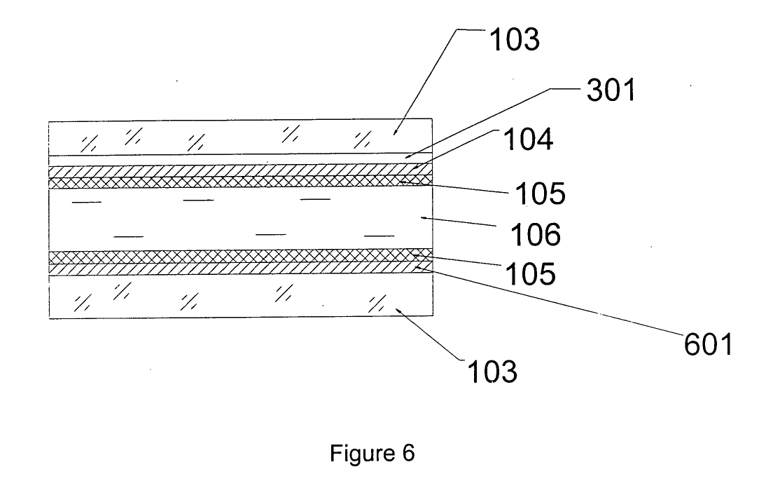

FIG. 6 shows a liquid crystal display according to one embodiment of the disclosed invention including a reflective layer 601 that also performs the electrode functions. This electrode/reflective layer 601 is arranged on the rear side of the display between a transparent substrate 103 and an alignment layer 105. One advantage of LCD shown in FIG. 6 is the use of ambient light and the small total thickness of layers of the display. The small total thickness of the layers provides for high angular characteristics and high brightness of the liquid crystal display.

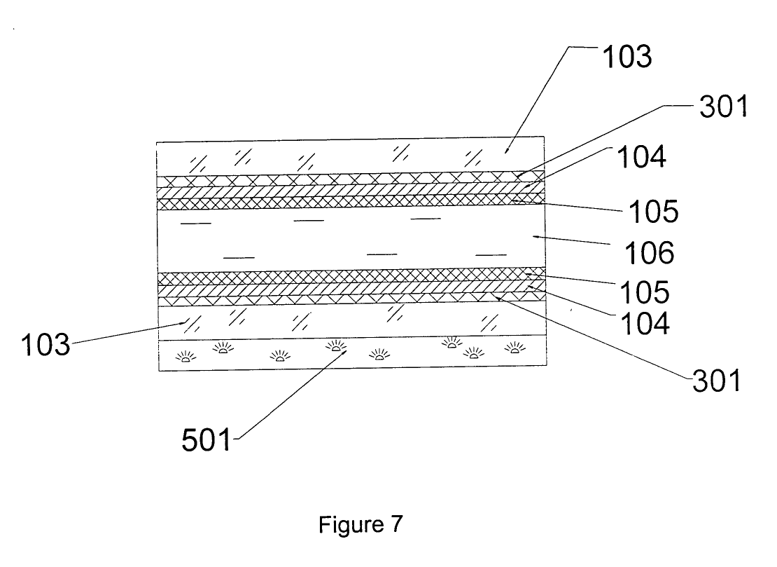

FIG. 7 shows a transmissive LCD according to one embodiment of the disclosed invention. The transmissive LCD includes a backlighting system 501 arranged on the rear side of the liquid crystal display. The backlighting system makes the disclosed liquid crystal display autonomous, independent of the ambient light.

The LCD provided by the present invention highly reduces LCD working voltage and electric capacitance, increases liquid crystal display image luminance and contrast, viewing angle, and stability with respect to mechanical damage of the surface. The disclosed invention does not make the manufacturing technology of liquid crystal displays more complicated. In addition, the LCD of the present invention reduces losses of the light flux in the liquid crystal display structure and thickness of the display.

The foregoing descriptions of specific embodiments of the invention have been presented for the purpose of illustration and description. They are not intended to be exhaustive or to limit the invention to the precise forms disclosed, and obviously many modifications, embodiments, and variations are possible in light of the above teaching. It is intended that the scope of the invention be defined by the claims appended hereto and their equivalents.

What is claimed is:

1. A liquid crystal display comprising:
a front panel,
a rear panel, and
a liquid crystal layer placed between two said panels,
wherein at least one of the front and rear panels comprises an internal polarizer situated between an electrode and a substrate in the panel, and said internal polarizer is made of a material chemically stable at an elevated temperature of at least 150° C.

2. The liquid crystal display according to claim 1, wherein said internal polarizer is made of an optically anisotropic dichroic crystal film that comprises rodlike supramolecules comprising at least one disc-shaped polycyclic organic compound with conjugated π-system, and said film being characterized by an intermolecular spacing of 3.4±0.3 Å along its polarization axis.

3. The liquid crystal display according to claim 2, wherein said optically anisotropic dichroic film is formed from a lyotropic liquid crystal containing at least one dichroic dye.

4. The liquid crystal display according to claim 1 or 2, wherein thickness of said internal polarizer is less than 1 micron.

5. The liquid crystal display according to claim 1, wherein the polarizer material is chemically stable at an elevated temperature of at least 200° C.

6. The liquid crystal display according to claim 1, further comprising an external polarizer situated on the panel other than said internal polarizer.

7. The liquid crystal display according to claim 1, wherein said rear panel further comprises a reflecting layer.

8. The liquid crystal display according to claim 1, wherein said rear panel further comprises a semitransparent reflective layer and a backlighting system.

9. The liquid crystal display according to claim 7 or 8, wherein said front panel further comprises a front lighting system.

10. The liquid crystal display according to claim 7 or 8, wherein said reflecting layer is diffusive.

11. The liquid crystal display according to claim 7 or 8, wherein said reflecting layer is specular.

12. The liquid crystal display according to claim 7 or 8, wherein said reflecting layer is conducting and performs the function of an electrode.

13. The liquid crystal display according to claim 8, further comprising at least one external polarizer.

14. The liquid crystal display according to claim 13, wherein the external polarizer is situated on the same panel as the internal polarizer.

15. The liquid crystal display according to claim 8 or 14, wherein said internal polarizer partially covers the substrate.

16. The liquid crystal display according to claim 1, wherein said rear panel comprises a backlighting system.

17. The liquid crystal display according to claim 1, wherein said polarizer performs the function of a phase retarder and/or correcting light filter.

18. The liquid crystal display according to claim 1, further comprising an antireflection or antiglare coating on a front surface of the display.

19. The liquid crystal display according to claim 1, further comprising at least one of functional layers selected from the group consisting of a retardation layer, a protective layer, a light-scattering layer, a planarization layer, a correcting light filter layer, and an insulating layer.

20. The liquid crystal display according to claim 1, further comprising a retardation layer made of an optically anisotropic dichroic crystal film that comprises rodlike supramolecules comprising at least one disc-shaped polycyclic organic compound with conjugated π-system, and said film being characterized by an intermolecular spacing of 3.4±0.3 Å along its polarization axis.

21. The liquid crystal display according to claim 1, wherein the thickness and the order of functional layers are selected so as ensure an interference extremum at the display output for at least one wavelength in the spectral range from 500 to 600 nm.

22. The liquid crystal display according to any of claims 6 or 13, wherein said external polarizer is made of an optically anisotropic dichroic crystal film that comprises rodlike supramolecules comprising at least one disc-shaped polycyclic organic compound with conjugated π-system, and said film being characterized by an intermolecular spacing of 3.4±0.3 Å along its polarization axis.

23. The liquid crystal display according to claim 22, wherein said optically anisotropic dichroic film is formed from a lyotropic liquid crystal containing at least one dichroic dye.
